(19) United States
(12) Patent Application Publication
(10) Pub. No.: US 2014/0161083 A1
(43) Pub. Date: Jun. 12, 2014

(54) RESOURCE ALLOCATION METHOD, WIRELESS COMMUNICATION SYSTEM, BASE STATION, AND PROGRAM

(71) Applicant: Takahiro Nobukiyo, Tokyo (JP)

(72) Inventor: Takahiro Nobukiyo, Tokyo (JP)

(73) Assignee: NEC CORPORATION, Tokyo (JP)

(21) Appl. No.: 14/232,348

(22) PCT Filed: Jul. 11, 2012
(86) PCT No.: PCT/JP2012/067677

§ 371 Date: Jan. 13, 2014

(30) Foreign Application Priority Data
Jul. 14, 2011 (JP) 2011-155954

(51) Int. Cl. H04W 72/04

(52) U.S. Cl. CPC H04W 72/0413; H04W 72/042
USPC 370/329

(57) ABSTRACT

The present invention is a wireless resource allocation method for a base station performing data communication with a wireless terminal with traffic having periodicity in intervals of occurrence, the method comprising: acquiring communication channel quality for the terminal; in case that the communication channel quality is greater than, or is equal to or greater than a threshold for quality decision, selecting a reservation-type scheduling method with which cyclically usable wireless resources are reserved; in case that the communication channel quality is equal to or smaller than, or is smaller than the threshold for quality decision, selecting a non-reservation-type scheduling method with which allocation information is notified to the terminal each time wireless resources are allocated; and performing data communication with the terminal using the selected scheduling method.

### TECHNICAL FIELD

The present invention relates to a resource allocation method, a wireless communication system, a base station, and a program.

### BACKGROUND ART

In cellular environments, such as LTE (Long Term Evolution) standardized in the 3GPP (3rd Generation Partnership Project), it is assumed that a plurality of wireless base stations are disposed, where each wireless base station communicates with wireless terminals within its communication area. The communication area is referred to as cell, which may be divided into a plurality of sub-regions by imparting directivity to an antenna. The sub-region is referred to as sector cell. In the following description, the term cell refers to a sector cell.

In LTE, dynamic scheduling and persistent scheduling are for a scheduling method. (Refer to NPL 1, for example.)

In dynamic scheduling, resources are allocated in each TTI (Transmission Time Interval) depending upon channel quality for a terminal A term resource refers to PRB (Physical Resource Block), which is a unit of allocation of a wireless band, and MCS (Modulation and Coding Schemes). While dynamic scheduling is capable of allocating PRB having good quality of reception because channel quality is used to achieve scheduling, scheduling information needs to be transmitted via a control channel each time resources are allocated. Therefore, in case that resources for the control channel become insufficient, the number of users that can perform transmission at the same transmission time is limited. In general, dynamic scheduling is applied to burst traffic having irregular intervals of occurrence or having an irregular size.

On the other hand, a reservation-type scheduling method, referred to as persistent scheduling, is a scheduling method taking advantage of regularity of the cycle of occurrence of traffic, which is encountered in VoIP (Voice over Internet Protocol) or the like, for reserving cyclically usable resources. By the reservation, transmission of scheduling information on a TTI-by-TTI basis can be omitted to avoid resource insufficiency for the control channel. Thus, persistent scheduling may be used in traffic with smaller data size, such as VoIP traffic, to significantly increase the number of terminals that can perform transmission at the same transmission time as compared with that in dynamic scheduling. In general, dynamic scheduling is applied to VoIP traffic that has periodicity in intervals of occurrence and has a smaller data size.

The VoIP traffic is comprised of a non-silent segment and a silent segment, and persistent scheduling that is applied to a specific segment, such as a non-silent segment, is particularly referred to as semi-persistent scheduling. The term non-silent segment refers to a segment in which voice packets successively arrive. The term silent segment refers to a segment in which background noise packets (SID (Silence Insertion Description) Packets) successively arrive.

The size of a packet occurring in a non-silent segment is greater than that of a packet occurring in a silent segment. Moreover, the cycle of occurrence of packets occurring in a non-silent segment is shorter than that of packets occurring in a silent segment. Generally, since a transmission fail in a silent segment does not affect QoS, persistent scheduling is applied only to a non-silent segment to avoid needless resource allocation to a silent segment.

### CITATION LIST

### Non Patent Literature

NPL 1: 3GPP TS 36.300 V9.7.0 (2011-03), 3GPP TSG RAN E-UTRA and E-UTRAN Overall description Stage 2, pp. 75-76

### SUMMARY OF INVENTION

### Technical Problem

When applying persistent scheduling to traffic cyclically occurring and having a smaller data size, such as VoIP traffic, however, a problem is caused that a delay in transmission of packets is increased, and QoS (Quality of Service) defined for each service in traffic, such as the allowable delay time (Delay Budget) or guaranteed bit rate (GBR), is not satisfied.

Persistent scheduling is a scheduling method in which PRB reserved beforehand is persistently allocated. Thus, when a received signal in the reserved PRB continually drops or the reserved PRB is continually subjected to strong interference from an adjacent cell, quality of reception is significantly degraded. Moreover, a terminal near cell edge is likely to fail to attain quality of reception to transmit voice packet data within one TTI, resulting in an increased number of retransmission. From these reasons, application of persistent scheduling causes a problem that QoS cannot be satisfied due to an increased likeliness of fails of packet transmission, leading to an increased delay of transmission.

The present invention has been made in view of such problems, and its object is to provide a resource allocation method, a wireless communication system, a base station, and a program capable of expanding the area (coverage) in which QoS is satisfied while maintaining the maximum number of admissible terminals (capacity).

### DISCLOSURE OF THE INVENTION

The present invention is a wireless resource allocation method for a base station performing data communication with a wireless terminal with traffic having periodicity in intervals of occurrence, said method comprising: acquiring communication channel quality for said terminal; in case that said communication channel quality is greater than, or is equal to or greater than a threshold for quality decision, selecting a reservation-type scheduling method with which cyclically usable wireless resources are reserved; in case that said communication channel quality is equal to or smaller than, or is smaller than said threshold for quality decision, selecting a non-reservation-type scheduling method with which allocation information is notified to said terminal each time wireless resources are allocated; and performing data communication with said terminal using said selected scheduling method.

The present invention is a wireless communication system comprised of a base station and a wireless terminal, for conducting wireless resource allocation to perform data communication between said base station and said wireless terminal with traffic having periodicity in intervals of occurrence, said base station comprising: a communication channel quality acquiring section for acquiring communication channel quality for said terminal; a scheduling method selecting section for, in case that said communication channel quality is greater than, or is equal to or greater than a threshold for quality decision, selecting a reservation-type scheduling method with which cyclically usable wireless resources are reserved, and in case that said communication channel quality is equal to or smaller than, or is smaller than the threshold for quality decision, selecting a non-reservation-type scheduling method with which allocation information is notified to said terminal each time wireless resources are allocated; and a scheduling section for performing data communication by applying said selected scheduling method to said terminal.

The present invention is a base station for conducting wireless resource allocation to perform data communication with a wireless terminal with traffic having periodicity in intervals of occurrence, said base station comprising: a communication channel quality acquiring section for acquiring communication channel quality for said terminal; a scheduling method selecting section for, in case that said communication channel quality is greater than, or is equal to or greater than a threshold for quality decision, selecting a reservation-type scheduling method with which cyclically usable wireless resources are reserved, and in case that said communication channel quality is equal to or smaller than, or is smaller than the threshold for quality decision, selecting a non-reservation-type scheduling method with which allocation information is notified to said terminal each time wireless resources are allocated; and a scheduling section for performing data communication by applying said selected scheduling method to said terminal.

The present invention is a program for a computer for conducting wireless resource allocation to perform data communication with a wireless terminal with traffic having periodicity in intervals of occurrence, said program causing a program to execute processing of: acquiring communication channel quality for said terminal; in case that said communication channel quality is greater than, or is equal to or greater than a threshold for quality decision, selecting a reservation-type scheduling method with which cyclically usable wireless resources are reserved, and in case that said communication channel quality is equal to or smaller than, or is smaller than the threshold for quality decision, selecting a non-reservation-type scheduling method with which allocation information is notified to said terminal each time wireless resources are allocated; and performing data communication with said terminal while applying said selected scheduling method.

### Advantageous Effects of Invention

According to the present invention, the area (coverage) in which QoS can be satisfied can be expanded while maintaining the maximum number of admissible terminals (capacity).

### BRIEF DESCRIPTION OF DRAWINGS

FIG. 1 is a flow chart showing a configuration of a wireless communications system in a first embodiment.

FIG. 2 is a flow chart showing decision processing for scheduling method selection in the first embodiment.

FIG. 3 is a flow chart showing decision processing for a non-silent segment and a silent segment in the first embodiment.

FIG. 4 is a flow chart showing decision processing for setting a scheduling method in the first embodiment.

FIG. 5 is a flow chart showing decision processing for scheduling method selection in a second embodiment.

FIG. 6 is a flow chart showing decision processing for scheduling method selection in a third embodiment.

FIG. 7 is a flow chart showing a configuration of a wireless communication system in a fourth embodiment.

FIG. 8 is a flow chart showing decision processing for a non-silent segment and a silent segment in the fourth embodiment.

### DESCRIPTION OF EMBODIMENTS

### First Embodiment

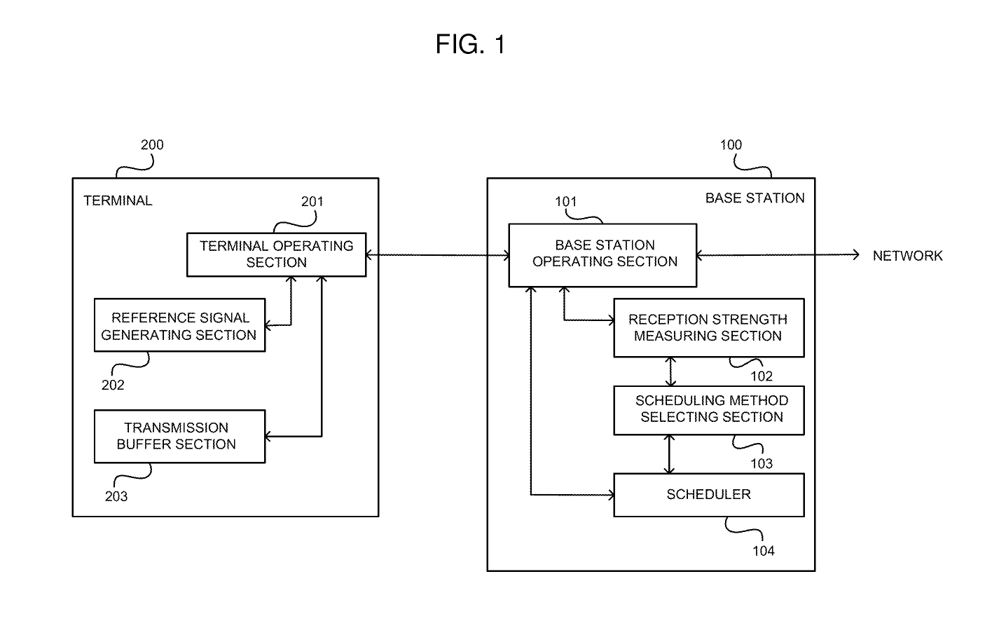

FIG. 1 is a block diagram showing a configuration of a wireless communication system in a first embodiment of the present invention.

Referring to FIG. 1, the wireless communication system includes a base station 100 and a terminal 200. The base station 100 is a wireless communication apparatus for performing wireless communication with the terminal 200 present in a communication area of the base station 100 through a wireless channel, and the base station 100 may be connected with a network (not shown) to perform data communication with adjacent base stations. Although not shown, the base station 100 can be connected with a plurality of terminals. A plurality of base stations may be present as well. A wireless band is divided into resource blocks (RBs) as the unit of allocation. In the present embodiment, LTE uplink is taken as an example for describing the wireless communication system.

The base station 100 comprises principal functional sections including a base station operating section 101, a reception strength measuring section 102, a scheduling method selecting section 103, and a scheduler 104.

The base station operating section 101 has a similar function to that of base stations commonly used in a wireless communication system, and description thereof will be omitted because its configuration and operation are widely known in the art.

The reception strength measuring section 102 has a function of measuring communication channel quality, such as a received power of reference signals and/or data signals received from a terminal, and SINR (Signal to Interference plus Noise Ratio), and reporting the result to the base station operating section 101 and/or scheduling method selecting section 103 as information on communication channel quality. To achieve scheduling depending upon communication channel quality for data signals, a signal component and an interference component are obtained using a result of the measurement of reference signals and a result of the measurement of data signals, respectively.

The scheduling method selecting section 103 has a function of deciding a non-silent segment and a silent segment in VoIP traffic of the terminal. The scheduling method selecting section 103 further has a function of deciding which of dynamic scheduling (DS: Dynamic Scheduling) and semi-persistent scheduling (SPS: Semi-Persistent Scheduling) is to be selected for the terminal based on the information on communication channel quality measured by the reception strength measuring section 102 and/or a buffer status report (BSR) from the terminal A result of the decision is notified to the scheduler 104. In this embodiment, the information on communication channel quality used in the scheduling method selecting section 103 is assumed to be SINR.

The scheduler 104 has a function of determining PRB to be allocated to the terminal 200 and MCS by dynamic scheduling or persistent scheduling based on a result of the decision by the scheduling method selecting section 103, and a function of deallocating resources allocated by persistent scheduling. Scheduling information for such allocation and deallocation is notified to the terminal via the base station operating section 101.

In dynamic scheduling, resources are allocated to maximize the transmission data size (TBS: Transport Block Size). TBS can be calculated referring to a look-up table and using the TBS index and number of allocated RBs. A method of calculating TBS is described in NPL 2 (3GPP TS 36.213 V9.3.0 (2010-09), 3GPP TSG RAN EUTRAN Physical layer procedures, pp. 27-34), for example. At that time, the TBS index may also be uniquely determined referring to a look-up table (NPL 2) and using the MCS index. The MCS index can be calculated referring to a look-up table and using the effective SINR for data signals. The effective SINR is a representative value of SINR for allocated RBs calculated taking account of variabilities in SINR of the RBs, which is measured by the reception strength measuring section 102. The look-up table for calculating an MCS index from SINR is generally created by link level simulation simulating a physical layer.

In persistent scheduling, resources are allocated using SINR averaged over all RBs usable in transmission of data signals so that a voice packet can be transmitted within one TTI.

The terminal 200 comprises principal functional sections including a terminal operating section 201, a reference signal generating section 202, and a transmission buffer section 203.

The terminal operating section 201 has a similar function to that of terminals commonly used in a wireless communication system, and description thereof will be omitted because its configuration and operation are widely known in the art.

The reference signal generating section 202 has a function of transmitting a reference signal serving as a basis of communication channel quality to the base station 100 via the terminal operating section 201 with certain timing.

The transmission buffer section 203 has a function of generating traffic data, and a function of transmitting (reporting) traffic information, such as the size of queued traffic (buffer size), in BSR via the terminal operating section 201 to the base station 100. In LTE, a logical wireless channel is generally established according to the traffic type. In uplink, a logical channel group is constructed from one or more logical channels, and BSR is reported for each logical channel group.

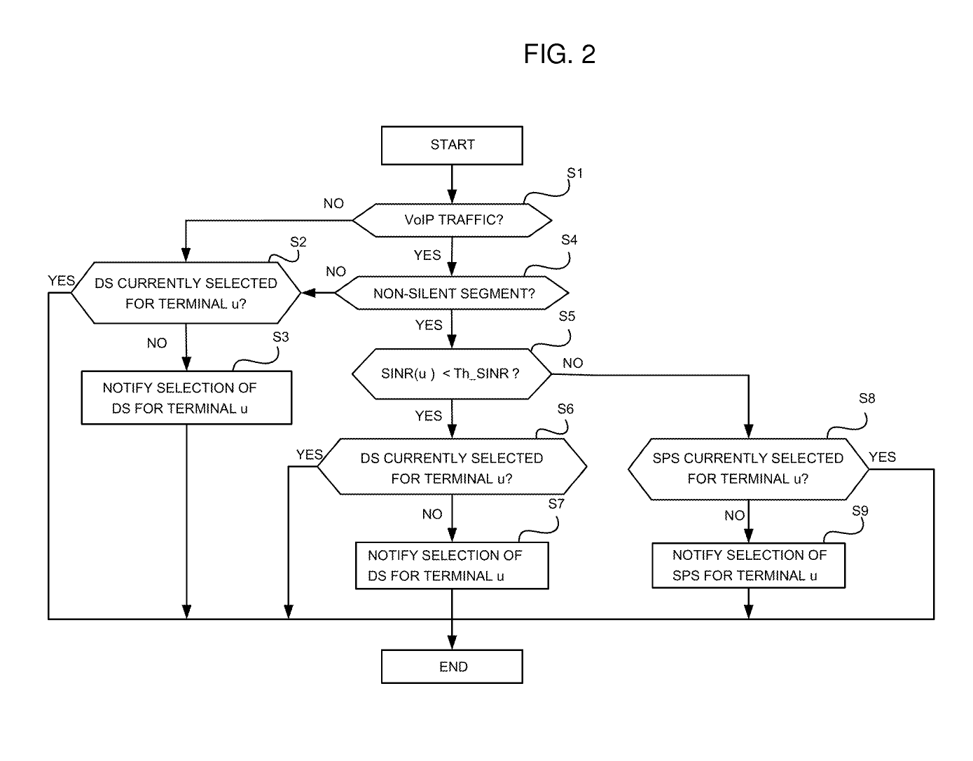

Next, an operation of the present embodiment will be described referring to FIGS. 2, 3 and 4.

FIG. 2 shows an operation procedure of the scheduling method selecting section 103 for deciding which of dynamic scheduling and semi-persistent scheduling is to be selected as a scheduling method for the terminal. This operation is conducted in a certain cycle defined for each terminal.

First, the scheduling method selecting section 103 decide whether traffic for a terminal u is VoIP traffic (S1). The decision of traffic is conducted using QCI (QoS Class Identifier) (refer to NPL 3: 3GPP TS 23.203 V9.9.0 (2011-06), 3GPP TSG SSA Policy and charging control architecture, pp. 30-33, for example) parameters. QCI can define QoS class definition to define a type of GBR and Non-GBR, Priority, Packet Delay Budget, and so forth.

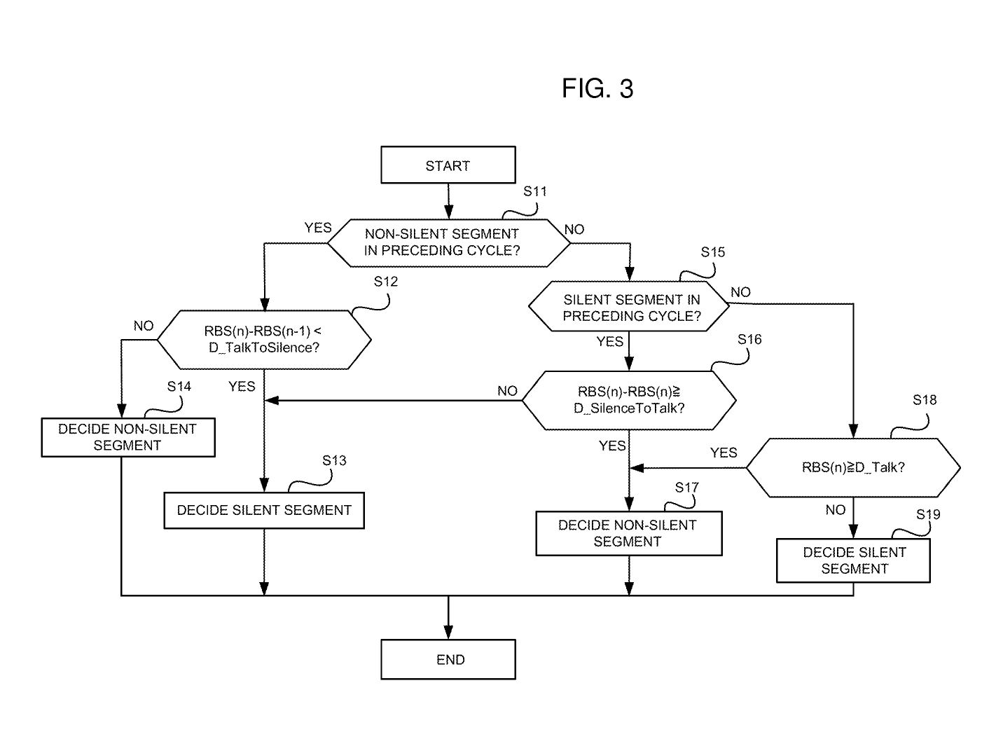

Next, in case that the traffic is not VoIP traffic (S1, No), and in case that dynamic scheduling is not currently selected for the terminal u (S2, No), the decision to select dynamic scheduling for the terminal u is notified to the scheduler 104 (S3). In case that the traffic is VoIP traffic (S1, Yes) and is not in a non-silent segment (S4, No), and in case that dynamic scheduling is not currently selected for the terminal u (S2, No), dynamic scheduling is selected for the terminal u (S3). An operation procedure for discriminating between a non-silent segment and a silent segment will be described with reference to FIG. 3.

Next, in case that the traffic is in a non-silent segment (S4, Yes), and SINR(u) in the information on communication channel quality is smaller than a threshold Th_SINR (S5, Yes), and in case that dynamic scheduling is not currently selected for the terminal u (S6, No), the decision to select dynamic scheduling for the terminal u is notified to the scheduler 104 (S7). In case that SINR(u) is equal to or greater than the threshold Th_SINR (S5, No), and in case that semi-persistent scheduling is not currently selected for the terminal u (S8, No), the decision to select semi-persistent scheduling for the terminal u is notified to the scheduler 104 (S9).

While the preceding description of the operation of the present embodiment addresses a case in which SINR(u) in the information on communication channel quality is smaller than the threshold Th_SINR (S5, Yes), and a case in which SINR(u) in the information on communication channel quality is equal to or greater than the threshold Th_SINR (S5, No), scheduling may be selected splitting the cases into one in which SINR(u) in the information on communication channel quality is equal to or smaller than the threshold Th_SINR, and one in which SINR(u) in the information on communication channel quality is greater than the threshold Th_SINR. This applies to description of the following embodiments.

FIG. 3 shows an operation procedure for the scheduling method selecting section 103 to decide the condition of VoIP traffic in a terminal between a non-silent segment or a silent segment. The present operation procedure is executed in a presumed cycle of arrival of voice packets.

First, in case that the scheduling method selecting section 103 decides that the condition was in a non-silent segment in a preceding cycle (S11, Yes), it compares the latest n-th BSR with the preceding ((n-1)-th) BSR, and in case that the amount of an increase of the buffer size (RBS(n)-RBS(n-1)) is smaller than a threshold D_TalkToSilence (S12, Yes), it decides that the condition transitions to a silent segment (S13). D_TalkToSilence is a threshold for deciding transition from a non-silent segment to a silent segment. On the other hand, in case that the amount is equal to or greater than D_TalkToSilence (S12, No), the section 103 decides that the condition is still in a non-silent segment (S14).

In case that the condition was not in a non-silent segment in the preceding cycle (S11, No), and is decided to be a silent segment (S15, Yes), and in case that the amount of an increase of the buffer size is equal to or greater than a threshold D_SilenceToTalk, which is different from that used in S12 (S16, Yes), the section 103 decides that the condition transitions to a non-silent segment (S17). D_SilenceToTalk is a threshold for deciding transition from a silent segment to a non-silent segment. On the other hand, in case that the amount is smaller than D_SilenceToTalk (S16, No), the section 103 decides that the condition is still in a silent segment (S13).

In case that the condition is not decided to be in a silent segment in the preceding cycle either, the current cycle is a first decision (S15, No). In this case, in case that RBS(n) is equal to or greater than a threshold D_Talk (S18, Yes), the condition is decided to be in a non-silent segment (S17), and in case that RBS(n) is smaller than D_Talk (S18, No), the condition is decided to be in a silent segment (S19). D_Talk is a threshold for deciding a non-silent segment.

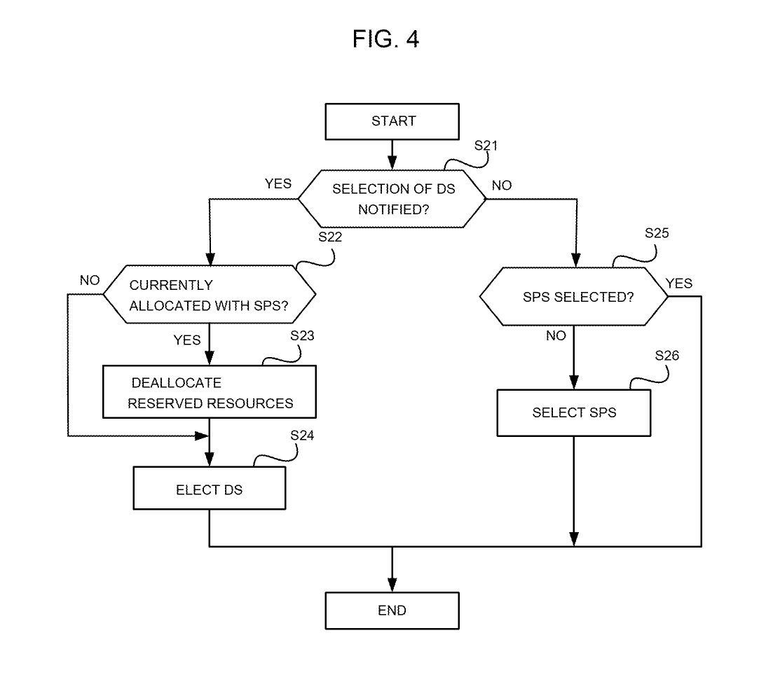

FIG. 4 shows an operation procedure for the scheduler 104 to set a scheduling method for a terminal based on a result of the decision by the scheduling method selecting section 103.

First, in case that the decision to select dynamic scheduling for the terminal u is notified from the scheduling method selecting section 103 (S21, Yes), and in case that resources are currently allocated to the terminal u with semi-persistent scheduling (S22, Yes), the scheduler 104 deallocates the reserved resources. Then, dynamic scheduling is selected as the scheduling method for the terminal u (S24).

In case that the decision to select semi-persistent scheduling for the terminal u is notified from the scheduling method selecting section 103 (S21, No), and in case that semi-persistent scheduling is not currently selected (S25, No), semi-persistent scheduling is newly selected and reservation of resources is made (S26).

For a terminal for which no scheduling method is selected, the scheduler 104 applies dynamic scheduling as an initial setting.

According to the present embodiment, since dynamic scheduling is selected for terminals having low SINR, and semi-persistent scheduling is selected for other terminals, coverage can be expanded by dynamic scheduling while avoiding degradation of capacity due to insufficient resources for the control channel for transmitting scheduling information.

While in this embodiment, selection of a scheduling method in FIG. 2 is applied only to VoIP traffic, the present invention is not limited thereto, and the selection may be applied to any traffic having periodicity in intervals of occurrence and having a smaller data size, such as traffic of gaming, for example, wherein traffic of a guaranteed bit rate (GBR) type having a smaller data size falls under such traffic.

While in this embodiment, decision of VoIP traffic in FIG. 2 is made once per terminal, the present invention is not limited thereto, and the decision may be made for each logical channel group, for example. In this case, persistent scheduling and dynamic scheduling may be employed in combination for terminals in which both VoIP traffic and burst traffic occur.

While in this embodiment, communication channel quality according to which a scheduling method is selected in FIG. 2 uses SINR, the present invention is not limited thereto, and a path loss difference, for example, between a current cell in the communication area of the current station and an adjacent cell in the communication area of an adjacent station may be used. Alternatively, a difference in the reference received power (RSRP: Reference Signal Received Power) between the current cell and an adjacent cell may be used. Alternatively, a ratio of the total received power to the reference signal received power (RSRQ: Reference Signal Received Quality) may be used.

While in this embodiment, transition between a non-silent segment and a silent segment in FIG. 3 is decided with reference to a result of only one measurement of the amount of an increase of the buffer size, the present invention is not limited thereto, and a decision that the condition transitions from a non-silent segment to a silent segment may be made at S12 in case that a condition in which (RBS(n)-RBS(n-1)) is smaller than D_TalkToSilence continues over N consecutive cycles, for example. This allows for fluctuations of the time of arrival of voice packets and improves accuracy in decision between a non-silent segment and a silent segment.

While in this embodiment, decision between a non-silent segment and a silent segment in FIG. 3 employs a difference in presumed size of packets between a non-silent segment and a silent segment, the present invention is not limited thereto, and, for example, a difference in presumed cycle of occurrence of packets between a non-silent segment and a silent segment may be employed. For example, a decision that the condition transitions from a non-silent segment to a silent segment may be made in a case the amount of an increase of the buffer size within a certain segment is smaller than a threshold.

While in this embodiment, decision between a non-silent segment and a silent segment in FIG. 3 employs BSR, the present invention is not limited thereto, and a condition of reception at a base station may be employed. For example, a decision that the condition transitions to a silent segment may be made in case that the base station does not receive traffic data equal to or greater than a threshold within a certain segment.

While in this embodiment, the present operation procedure as in FIG. 2 or 3 is conducted only in a certain cycle, the present invention is not limited thereto, and it may be conducted when connection is established between a terminal and a base station, for example.

As described above, according to the present embodiment, for traffic having periodicity in intervals of occurrence and having a smaller data size, the area in which QoS can be satisfied can be expanded while avoiding restrictions on the number of users that can perform transmission at the same transmission time due to insufficient resources for a control channel for transmitting scheduling information.

The reason thereof is that, in case that said communication channel quality is equal to or greater than a threshold for quality decision, a reservation-type scheduling method in which cyclically usable wireless resources are reserved is selected, and in case that the quality is smaller than the threshold for quality decision, a non-reservation-type scheduling method in which allocation information is notified to the terminal each time wireless resources are allocated is selected, so that data communication with the terminal is performed using the selected scheduling method.

### Second Embodiment

Next, a second embodiment of the present invention will be described.

Since a block diagram showing a configuration of a wireless communication system in the second embodiment is similar to that of the first embodiment, detailed description thereof will be omitted.

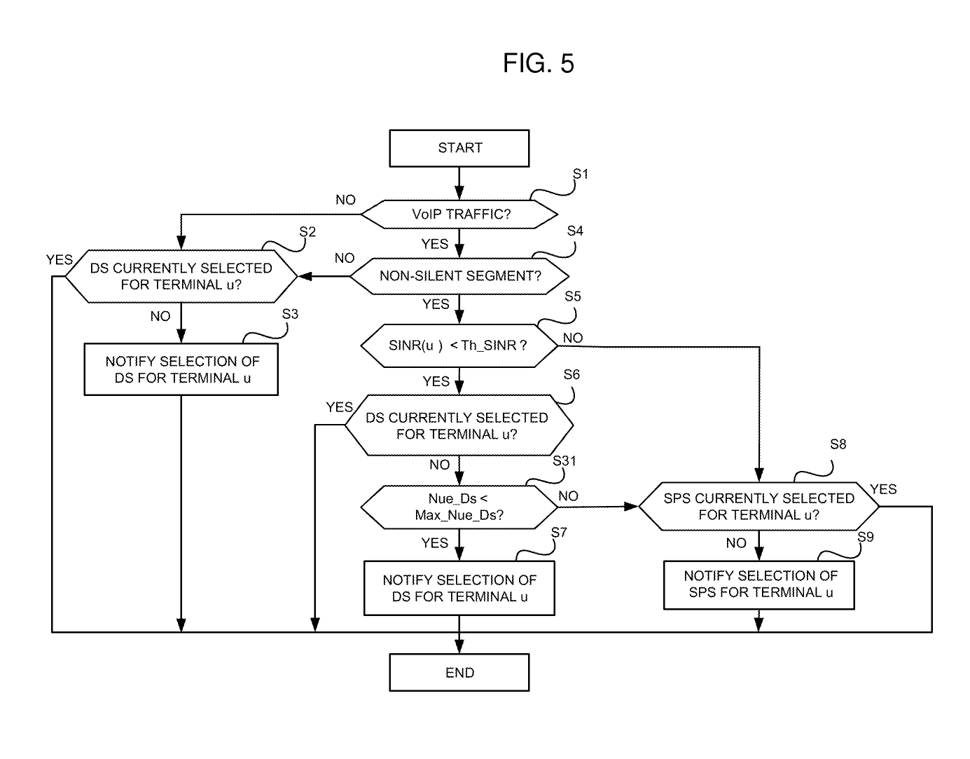

Next, an operation of the second embodiment will be described referring to the accompanying drawings. The second embodiment is different from the first embodiment in that an operation shown in FIG. 5, in place of FIG. 2, is conducted.

Referring to FIG. 5, S31 is added after “No” at S6 in FIG. 2. Specifically, in case that dynamic scheduling is not currently selected for the terminal u (S6, No), and in case that the number Nue_DS of terminals for which dynamic scheduling is currently selected is smaller than a maximum number Max_Nue_DS of terminals to which dynamic scheduling is applicable, the maximum number being predefined beforehand for terminals with VoIP traffic (S31, Yes), the scheduling method selecting section 103 notifies the decision to select dynamic scheduling for the terminal u to the scheduler 104 (S7).

On the other hand, in case that Nue_DS is equal to or greater than Max_Nue_DS (S31, No), the process goes to S8, and a decision is made as to whether semi-persistent scheduling is currently selected for the terminal u.

While the present embodiment addresses a case in which the decision to select dynamic scheduling for the terminal u is notified to the scheduler 104 when the number Nue_DS of terminals is smaller than the maximum number Max_Nue_DS of terminals, the decision to select dynamic scheduling for the terminal u may be notified to the scheduler 104 when the number Nue_DS of terminals is equal to or smaller than the maximum number Max_Nue_DS of terminals. This applies to description of the following embodiments.

According to the present embodiment, as compared with the first embodiment, restrictions on the number of terminals that can perform transmission at the same transmission time and that occur when resources for a control channel for transmitting scheduling information in dynamic scheduling become insufficient, may be avoided.

While in this embodiment, Max_Nue_DS is a predefined fixed value, the present invention is not limited thereto, and it may be changed depending upon the condition of a traffic load. For example, Max_Nue_DS may be increased for a smaller number of terminals with burst traffic and decreased for a greater number of terminals with burst traffic, whereby improved coverage may be prioritized by increasing the number of VoIP terminals to which dynamic scheduling may be applied for a smaller number of terminals with burst traffic, and suppression of resource insufficiency for a control channel may be prioritized by decreasing the number of VoIP terminals to which dynamic scheduling may be applied for a greater number of terminals with burst traffic.

### Third Embodiment

Next, a third embodiment of the present invention will be described.

Since a block diagram showing a configuration of a wireless communication system in the third embodiment is similar to that of the first embodiment, detailed description thereof will be omitted.

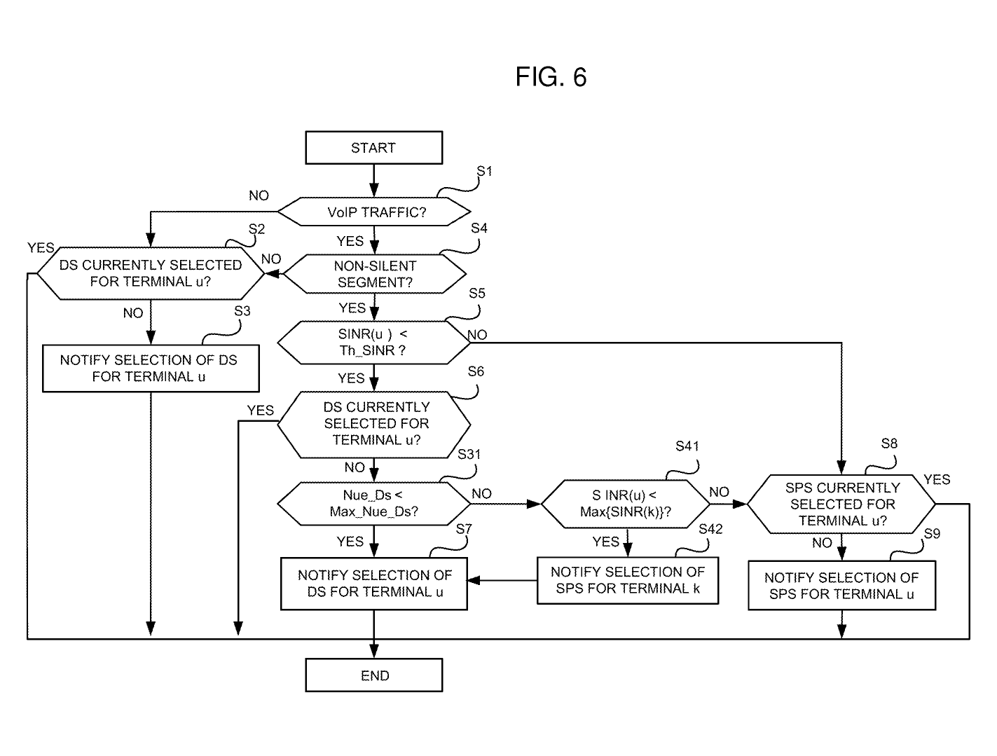

Next, an operation of the present embodiment will be described referring to the accompanying drawings. The third embodiment is different from the second embodiment in that an operation shown in FIG. 6, in place of FIG. 5, is conducted.

Referring to FIG. 6, S41 and S42 are added after “No” at S31 in FIG. 5. Specifically, in case that Nue_DS is smaller than Max Nue_DS (S31, Yes), the scheduling method selecting section 103 compares SINR of the terminal u (SINR(u)) with that of another terminal k (SINR(k)) (S41). The terminal k is a terminal to which dynamic scheduling is applied for VoIP traffic, except the terminal u. Max{ } designates a function for selecting a maximum value, and when there are a plurality of terminals, a terminal k having maximal SINR, except u, and its SINR are selected.

In case that SINR(u) is smaller than Max {SINR(k)} (S41, Yes), the decision to change a scheduling method selected for the terminal k from dynamic scheduling to semi-persistent scheduling is notified to the scheduler 104 (S42). Then, the decision to select dynamic scheduling for the terminal u is notified to the scheduler 104 (S7). In case that SINR(u) is equal to or greater than Max {SINR(k)} (S41, No), the process goes to S8, and a decision is made as to whether semi-persistent scheduling is currently selected for the terminal u.

According to the present embodiment, as compared with the second embodiment, dynamic scheduling may be selected while prioritizing terminals having lower SINR, so that coverage may be further improved while avoiding restrictions on the number of terminals that can perform transmission at the same transmission time and that occur when resources for a control channel for transmitting scheduling information in dynamic scheduling become insufficient.

### Fourth Embodiment

Next, a fourth embodiment of the present invention will be described. In the present embodiment, LTE downlink is taken as an example for the wireless communication system.

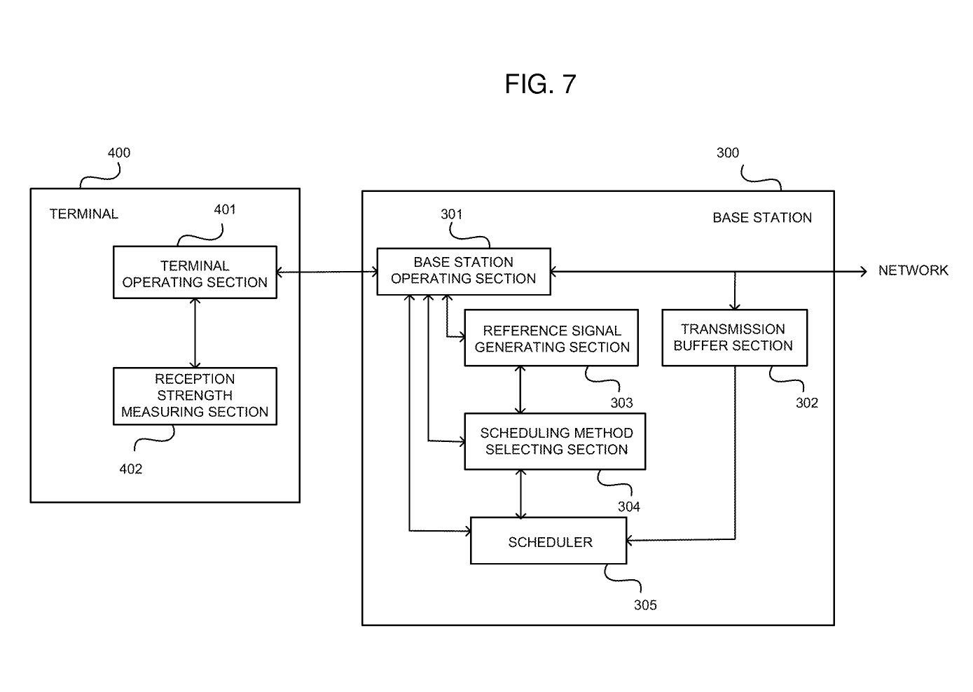

FIG. 7 is a block diagram showing a configuration of a wireless communication system in the present embodiment.

A base station 300 comprises principal functional sections including a base station operating section 301, a transmission buffer section 302, a reference signal generating section 303, a scheduling method selecting section 304, and a scheduler 305.

The base station operating section 301 is similar to the base station operating section 101 in the first embodiment shown in FIG. 1.

The transmission buffer section 302 has a function of keeping traffic data arriving from a network along with information for decision about a destination terminal and traffic, and the buffer size.

The reference signal generating section 303 has a function of transmitting a reference signal serving as a basis of communication channel quality to a base station 400 via the base station operating section 301 with certain timing.

The scheduling method selecting section 304, similar to the scheduling method selecting section 103 in the first embodiment shown in FIG. 1, has a function of deciding a non-silent segment and a silent segment in VoIP traffic for the terminal. The scheduling method selecting section 304 further has a function of deciding which of dynamic scheduling and semi-persistent scheduling is to be selected for the terminal based on the information on the communication channel reported from the terminal 400 and received by the base station operating section 301, and on traffic information kept in the transmission buffer section 302. A result of the decision is notified to the scheduler 305.

In the present embodiment, CQI (Channel Quality Information) is employed as the information on communication channel quality for use in the scheduling method selecting section 304. CQI may be calculated referring to a look-up table and using SINR. The look-up table is generally created by link level simulation simulating a physical layer.

The scheduler 305 is similar to the scheduler 104 in the first embodiment shown in FIG. 1.

The terminal 400 comprises principal functional sections including a terminal operating section 401, and a reception strength measuring section 402.

The terminal operating section 401 is similar to the terminal operating section 201 in the first embodiment shown in FIG. 1.

The reception strength measuring section 402 has a function of measuring communication channel quality, such as a received power of reference signals and/or data signals received from the base station 300, and CQI, and reporting the result to the base station 300 via the terminal operating section 401 as information on communication channel quality.

It should be noted that no logical channel group is constructed for the downlink, unlike the uplink. The base station 300 can directly confirm the buffer size of the transmission buffer section 302, or the like, for each logical channel.

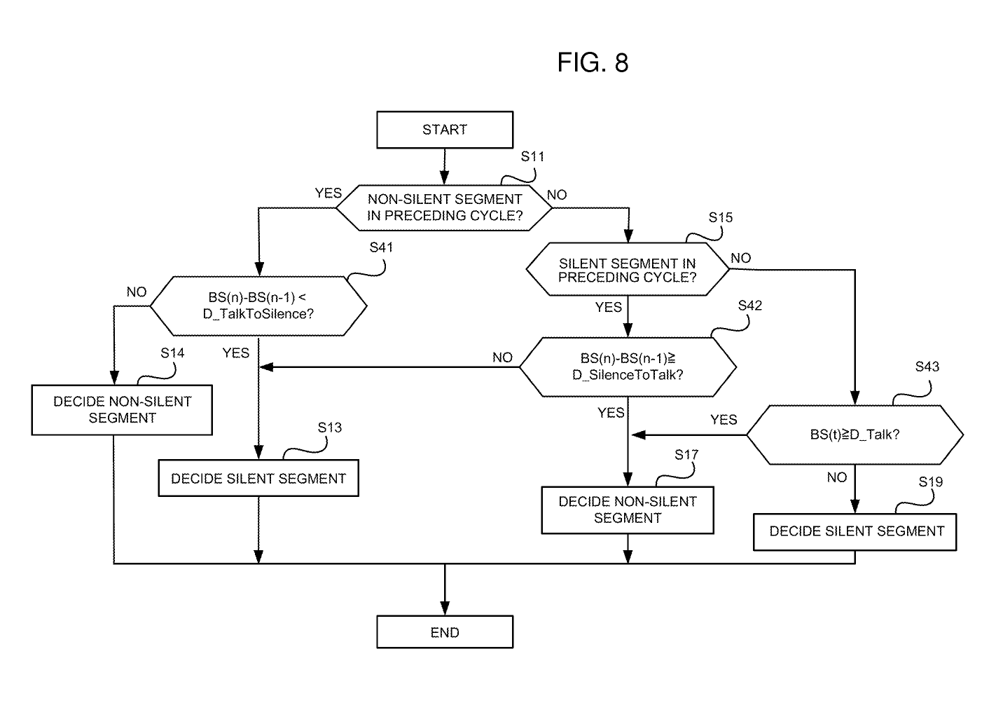

Next, an operation of the present embodiment will be described referring to the accompanying drawings. The fourth embodiment is different from the first embodiment in that an operation shown in FIG. 8, in place of FIG. 3, is conducted.

Referring to FIG. 8, the decision processing at S12, S16, and S18 in FIG. 3 are replaced by S41, S42, and S43, respectively. Specifically, the scheduling method selecting section 304 compares the current buffer size with that in a preceding cycle, and in case that a non-silent segment in the preceding cycle is decided (S11, Yes), it compares the amount of an increase of the current buffer size from that in the preceding cycle (BS(n)-BS(n-1)), and in case that the amount of an increase in buffer size is smaller than a threshold D_TalkToSilence (S41, Yes), it decides that the condition transitions to a silent segment (S13).

Likewise, in case that a silent segment in the preceding cycle is decided (S15, Yes), and in case that the amount of an increase in buffer size is equal to or greater than a threshold D_SilenceToTalk (S42, Yes), the section 304 decides that the condition transitions to a non-silent segment (S17).

In case that the current cycle is a first decision (S15, No), a non-silent segment is decided (S17) for BS(n) equal to or greater than a threshold D_Talk (S43, Yes), or a silent segment is decided (S19) for BS(n) smaller than the threshold D_Talk (S43, No).

While the present invention has been described with reference to several embodiments, the present invention is not limited to these embodiments.

For example, the present invention may be applied to other systems capable of using dynamic scheduling for allocating resources on a TTI-by-TTI basis and reservation-type scheduling in combination.

Moreover, the present invention may be applied to a system comprised of a plurality of devices, or to a single apparatus. Furthermore, the present invention may be applied to a case in which programs implementing the functions described in the embodiments above are supplied from the system or from a remote system to execute processing of the operation procedures described in these embodiments. Therefore, programs installed in a base station and executed by a processor in the base station, media storing therein the programs, and servers for downloading the programs therefrom for implementing the functions of the present invention in the base station may fall within the scope of the present invention.

Part or all of the preceding embodiments may be described as in the following Supplementary notes, although not limited thereto.

(Supplementary note 1) A wireless resource allocation method for a base station performing data communication with a wireless terminal with traffic having periodicity in intervals of occurrence, said method comprising:

acquiring communication channel quality for said terminal;

in case that said communication channel quality is greater than, or is equal to or greater than a threshold for quality decision, selecting a reservation-type scheduling method with which cyclically usable wireless resources are reserved;

in case that said communication channel quality is equal to or smaller than, or is smaller than said threshold for quality decision, selecting a non-reservation-type scheduling method with which allocation information is notified to said terminal each time wireless resources are allocated; and

performing data communication with said terminal using said selected scheduling method.

(Supplementary note 2) The wireless resource allocation method as recited in Supplementary note 1, wherein:

said traffic is voice traffic.

(Supplementary note 3) The wireless resource allocation method as recited in Supplementary note 1, wherein:

said traffic is gaming traffic.

(Supplementary note 4) The wireless resource allocation method as recited in Supplementary note 1, wherein:

said traffic is traffic of a guaranteed bit rate type having a data size smaller than a data size threshold.

(Supplementary note 5) The wireless resource allocation method as recited in any one of Supplementary notes 1 through 4, wherein:

said data communication is uplink data communication.

(Supplementary note 6) The wireless resource allocation method as recited in any one of Supplementary notes 1 through 4, wherein:

said data communication is downlink data communication.

(Supplementary note 7) The wireless resource allocation method as recited in any one of Supplementary notes 1 through 6, comprising:

measuring a number of terminals for which said non-reservation-type scheduling method is currently selected; and

in case that said number of terminals for which said method is currently selected is greater than, or is equal to or greater than a threshold of the number of admissible terminals, selecting reservation-type scheduling.

(Supplementary note 8) The wireless resource allocation method as recited in any one of Supplementary notes 1 through 6, comprising:

measuring a number of terminals for which said non-reservation-type scheduling method is currently selected;

searching for a high-quality terminal for which a non-reservation-type scheduling method is currently selected and which has communication channel quality higher than said terminal; and

in case that said number of terminals for which said method is currently selected is a threshold of the number of admissible terminals, selecting a reservation-type scheduling method for said high-quality terminal, and selecting a non-reservation-type scheduling method for said terminal.

(Supplementary note 9) The wireless resource allocation method as recited in Supplementary note 7 or 8, comprising:

measuring a number of terminals for which no scheduling method selection is made and which is currently performing data communication with traffic having no periodicity in intervals of occurrence; and

changing said threshold of the number of admissible terminals according to said number of terminals for which no method selection is made.

(Supplementary note 10) A wireless communication system comprised of a base station and a wireless terminal, for conducting wireless resource allocation to perform data communication between said base station and said wireless terminal with traffic having periodicity in intervals of occurrence, said base station comprising:

a communication channel quality acquiring section for acquiring communication channel quality for said terminal;

a scheduling method selecting section for, in case that said communication channel quality is greater than, or is equal to or greater than a threshold for quality decision, selecting a reservation-type scheduling method with which cyclically usable wireless resources are reserved, and in case that said communication channel quality is equal to or smaller than, or is smaller than the threshold for quality decision, selecting a non-reservation-type scheduling method with which allocation information is notified to said terminal each time wireless resources are allocated; and

a scheduling section for performing data communication while applying said selected scheduling method to said terminal.

(Supplementary note 11) The wireless communication system as recited in Supplementary note 10, wherein:

said traffic is voice traffic.

(Supplementary note 12) The wireless communication system as recited in Supplementary note 10, wherein:

said traffic is gaming traffic.

(Supplementary note 13) The wireless communication system as recited in Supplementary note 1, wherein:

said traffic is traffic of a guaranteed bit rate type having a data size smaller than a data size threshold.

(Supplementary note 14) The wireless communication system as recited in any one of Supplementary notes 10 through 13, wherein:

said data communication is uplink data communication.

(Supplementary note 15) The wireless communication system as recited in any one of Supplementary notes 10 through 13, wherein:

said data communication is downlink data communication.

(Supplementary note 16) The wireless communication system as recited in any one of Supplementary notes 10 through 15, wherein:

said scheduling method selecting section measures a number of terminals for which said non-reservation-type scheduling method is currently selected, and in case that said number of terminals for which said method is currently selected is greater than, or is equal to or greater than a threshold of the number of admissible terminals, selects reservation-type scheduling.

(Supplementary note 17) The wireless communication system as recited in any one of Supplementary notes 10 through 15, wherein:

said scheduling method selecting section measures a number of terminals for which said non-reservation-type scheduling method is currently selected; searches for a high-quality terminal for which a non-reservation-type scheduling method is currently selected and which has communication channel quality higher than said terminal; and in case that said number of terminals for which said method is currently selected is a threshold of the number of admissible terminals, selects a reservation-type scheduling method for said high-quality terminal, and selects a non-reservation-type scheduling method for said terminal.

(Supplementary note 18) The wireless communication system as recited in Supplementary note 16 or 17, wherein:

said scheduling method selecting section measures a number of terminals for which no scheduling method selection is made and which is currently performing data communication with traffic having no periodicity in intervals of occurrence; and changes said threshold of the number of admissible terminals according to said number of terminals for which no method selection is made.

(Supplementary note 19) A base station for conducting wireless resource allocation to perform data communication with a wireless terminal with traffic having periodicity in intervals of occurrence, said base station comprising:

a communication channel quality acquiring section for acquiring communication channel quality for said terminal;

a scheduling method selecting section for, in case that said communication channel quality is greater than, or is equal to or greater than a threshold for quality decision, selecting a reservation-type scheduling method with which cyclically usable wireless resources are reserved, and in case that said communication channel quality is equal to or smaller than, or is smaller than the threshold for quality decision, selecting a non-reservation-type scheduling method with which allocation information is notified to said terminal each time wireless resources are allocated; and

a scheduling section for performing data communication while applying said selected scheduling method to said terminal.

(Supplementary note 20) The base station as recited in Supplementary note 19, wherein:

said traffic is voice traffic.

(Supplementary note 21) The base station as recited in Supplementary note 19, wherein:

said traffic is gaming traffic.

(Supplementary note 22) The base station as recited in Supplementary note 19, wherein:

said traffic is traffic of a guaranteed bit rate type having a data size smaller than a data size threshold.

(Supplementary note 23) The base station as recited in any one of Supplementary notes 19 through 22, wherein:

said data communication is uplink data communication.

(Supplementary note 24) The base station as recited in any one of Supplementary notes 19 through 22, wherein:

said data communication is downlink data communication.

(Supplementary note 25) The base station as recited in any one of Supplementary notes 19 through 24, wherein:

said scheduling method selecting section measures a number of terminals for which said non-reservation-type scheduling method is currently selected, and in case that said number of terminals for which said method is currently selected is greater than, or is equal to or greater than a threshold of the number of admissible terminals, selects reservation-type scheduling.

(Supplementary note 26) The base station as recited in any one of Supplementary notes 19 through 24, wherein:

said scheduling method selecting section measures a number of terminals for which said non-reservation-type scheduling method is currently selected; searches for a high-quality terminal for which a non-reservation-type scheduling method is currently selected and which has communication channel quality higher than said terminal; and in case that said number of terminals for which said method is currently selected is a threshold of the number of admissible terminals, selects a reservation-type scheduling method for said high-quality terminal, and selects a non-reservation-type scheduling method for said terminal.

(Supplementary note 27) The base station as recited in Supplementary note 25 or 26, wherein:

said scheduling method selecting section measures a number of terminals for which no scheduling method selection is made and which is currently performing data communication with traffic having no periodicity in intervals of occurrence; and changes said threshold of the number of admissible terminals according to said number of terminals for which no method selection is made.

(Supplementary note 28) A program for a computer for conducting wireless resource allocation to perform data communication with a wireless terminal with traffic having periodicity in intervals of occurrence, said program causing a program to execute:

communication channel quality acquiring processing of acquiring communication channel quality for said terminal;

scheduling method selecting processing of, in case that said communication channel quality is greater than, or is equal to or greater than a threshold for quality decision, selecting a reservation-type scheduling method with which cyclically usable wireless resources are reserved, and in case that said communication channel quality is equal to or smaller than, or is smaller than the threshold for quality decision, selecting a non-reservation-type scheduling method with which allocation information is notified to said terminal each time wireless resources are allocated; and

scheduling processing of performing data communication with said terminal while applying said selected scheduling method.

(Supplementary note 29) The program as recited in Supplementary note 28, wherein:

said traffic is voice traffic.

(Supplementary note 30) The program as recited in Supplementary note 28, wherein:

said traffic is gaming traffic.

(Supplementary note 31) The program as recited in Supplementary note 28, wherein:

said traffic is traffic of a guaranteed bit rate type having a data size smaller than a data size threshold.

(Supplementary note 32) The program as recited in any one of Supplementary notes 28 through 31, wherein:

said data communication is uplink data communication.

(Supplementary note 33) The program as recited in any one of Supplementary notes 28 through 31, wherein:

said data communication is downlink data communication.

(Supplementary note 34) The program as recited in any one of Supplementary notes 28 through 33, comprising the processing of:

measuring a number of terminals for which said non-reservation-type scheduling method is currently selected,

wherein in case that said number of terminals for which said method is currently selected is greater than, or is equal to or greater than a threshold of the number of admissible terminals, said scheduling method selection processing selects reservation-type scheduling.

(Supplementary note 35) The program as recited in any one of Supplementary notes 28 through 33, comprising the processing of:

measuring a number of terminals for which said non-reservation-type scheduling method is currently selected,

wherein said scheduling method selection processing searches for a high-quality terminal for which a non-reservation-type scheduling method is currently selected and which has communication channel quality higher than said terminal; and in case that said number of terminals for which said method is currently selected is a threshold of the number of admissible terminals, selects a reservation-type scheduling method for said high-quality terminal, and selects a non-reservation-type scheduling method for said terminal.

(Supplementary note 36) The program as recited in Supplementary note 34 or 35, comprising the processing of:

measures a number of terminals for which no scheduling method selection is made and which is currently performing data communication with traffic having no periodicity in intervals of occurrence,

wherein said scheduling method selection processing changes said threshold of the number of admissible terminals according to said number of terminals for which no method selection is made.

While the present invention has been described with reference to preferred embodiments, the present invention is not necessarily limited to the embodiments described above, and several modifications may be made within a scope of the technical idea thereof.

The present application claims priority based on Japanese patent application No. 2011-155954 filed on Jul. 14, 2011, disclosure of which is incorporated herein in its entirety.

### REFERENCE SIGNS LIST

100 Base station
101 Base station operating section
102 Reception strength measuring section
103 Scheduling method selecting section
104 Scheduler
200 Terminal
201 Terminal operating section
202 Reference signal generating section
203 Transmission buffer section
300 Base station
301 Base station operating section
302 Transmission buffer section
303 Reference signal generating section
304 Scheduling method selecting section
305 Scheduler
400 Terminal
401 Terminal operating section
402 Reception strength measuring section

1. A wireless resource allocation method for a base station performing data communication with a wireless terminal with traffic having periodicity in intervals of occurrence, said method comprising:
acquiring communication channel quality for said terminal;
in case that said communication channel quality is greater than, or is equal to or greater than a threshold for quality decision, selecting a reservation-type scheduling method with which cyclically usable wireless resources are reserved;
in case that said communication channel quality is equal to or smaller than, or is smaller than said threshold for quality decision, selecting a non-reservation-type scheduling method with which allocation information is notified to said terminal each time wireless resources are allocated; and
performing data communication with said terminal using said selected scheduling method.

2. The wireless resource allocation method according to claim 1, wherein said traffic is voice traffic.

3. The wireless resource allocation method according to claim 1, wherein said traffic is gaming traffic.

4. The wireless resource allocation method according to claim 1, wherein said traffic is traffic of a guaranteed bit rate type having a data size smaller than a data size threshold.

5. The wireless resource allocation method according to claim 1, wherein said data communication is uplink data communication.

6. The wireless resource allocation method according to claim 1, wherein said data communication is downlink data communication.

7. The wireless resource allocation method according to claim 1, comprising:
measuring a number of terminals for which said non-reservation-type scheduling method is currently selected; and
in case that said number of terminals for which said method is currently selected is greater than, or is equal to or greater than a threshold of the number of admissible terminals, selecting reservation-type scheduling.

8. The wireless resource allocation method according to claim 1, comprising:
measuring a number of terminals for which said non-reservation-type scheduling method is currently selected;
searching for a high-quality terminal for which a non-reservation-type scheduling method is currently selected and which has communication channel quality higher than said terminal; and
in case that said number of terminals for which said method is currently selected is a threshold of the number of admissible terminals, selecting a reservation-type scheduling method for said high-quality terminal, and selecting a non-reservation-type scheduling method for said terminal.

9. The wireless resource allocation method according to claim 7, comprising:
measuring a number of terminals for which no scheduling method selection is made and which is currently performing data communication with traffic having no periodicity in intervals of occurrence; and
changing said threshold of the number of admissible terminals according to said number of terminals for which no method selection is made.

10. A wireless communication system comprised of a base station and a wireless terminal, for conducting wireless resource allocation to perform data communication between said base station and said wireless terminal with traffic having periodicity in intervals of occurrence, said base station comprising:
a communication channel quality acquiring section configured to acquire communication channel quality for said terminal;
a scheduling method selecting section configured to, in case that said communication channel quality is greater than, or is equal to or greater than a threshold for quality decision, select a reservation-type scheduling method with which cyclically usable wireless resources are reserved, and in case that said communication channel quality is equal to or smaller than, or is smaller than the threshold for quality decision, select a non-reservation-type scheduling method with which allocation information is notified to said terminal each time wireless resources are allocated; and
a scheduling section configured to perform data communication while applying said selected scheduling method to said terminal.

11. The wireless communication system according to claim 10, wherein said traffic is voice traffic.

12. The wireless communication system according to claim 10, wherein said traffic is gaming traffic.

13. The wireless communication system according to claim 10, wherein said traffic is traffic of a guaranteed bit rate type having a data size smaller than a data size threshold.

14. The wireless communication system according to claim 10, wherein said data communication is uplink data communication.

15. The wireless communication system according to claim 10, wherein said data communication is downlink data communication.

16. The wireless communication system according to claim 10, wherein:
said scheduling method selecting section measures a number of terminals for which said non-reservation-type scheduling method is currently selected, and in case that said number of terminals for which said method is currently selected is greater than, or is equal to or greater than a threshold of the number of admissible terminals, selects reservation-type scheduling.

17. The wireless communication system according to claim 10, wherein:
said scheduling method selecting section measures a number of terminals for which said non-reservation-type scheduling method is currently selected; searches for a high-quality terminal for which a non-reservation-type scheduling method is currently selected and which has communication channel quality higher than said terminal; and in case that said number of terminals for which said method is currently selected is a threshold of the number of admissible terminals, selects a reservation-type scheduling method for said high-quality terminal, and selects a non-reservation-type scheduling method for said terminal.

18. The wireless communication system according to claim 16, wherein:
said scheduling method selecting section measures a number of terminals for which no scheduling method selection is made and which is currently performing data communication with traffic having no periodicity in intervals of occurrence; and changes said threshold of the number of admissible terminals according to said number of terminals for which no method selection is made.

19. A base station for conducting wireless resource allocation to perform data communication with a wireless terminal with traffic having periodicity in intervals of occurrence, said base station comprising:
a communication channel quality acquiring section configured to acquire communication channel quality for said terminal;
a scheduling method selecting section configured to, in case that said communication channel quality is greater than, or is equal to or greater than a threshold for quality decision, select a reservation-type scheduling method with which cyclically usable wireless resources are reserved, and in case that said communication channel quality is equal to or smaller than, or is smaller than the threshold for quality decision, select a non-reservation-type scheduling method with which allocation information is notified to said terminal each time wireless resources are allocated; and
a scheduling section configured to perform data communication while applying said selected scheduling method to said terminal.

20. (canceled)

21. (canceled)

22. (canceled)

23. (canceled)

24. (canceled)

25. (canceled)

26. (canceled)

27. (canceled)

28. A non-transitory computer readable storage medium storing a program for a computer for conducting wireless resource allocation to perform data communication with a wireless terminal with traffic having periodicity in intervals of occurrence, said program causing a program to execute:
communication channel quality acquiring processing of acquiring communication channel quality for said terminal;
scheduling method selecting processing of, in case that said communication channel quality is greater than, or is equal to or greater than a threshold for quality decision, selecting a reservation-type scheduling method with which cyclically usable wireless resources are reserved, and in case that said communication channel quality is equal to or smaller than, or is smaller than the threshold for quality decision, selecting a non-reservation-type scheduling method with which allocation information is notified to said terminal each time wireless resources are allocated; and
scheduling processing of performing data communication with said terminal while applying said selected scheduling method.
